(19) United States
(12) Patent Application Publication
(10) Pub. No.: US 2002/0078265 A1
(43) Pub. Date: Jun. 20, 2002

(54) Method and apparatus for transferring data in a network data processing system

(76) Inventors: Giles Roger Frazier, Austin, TX (US); Gregory Francis Pfister, Austin, TX (US)

Correspondence Address: Duke W. Yee, Carstens, Yee & Cahoon, LLP, P.O. Box 802334, Dallas, TX, 75380, US

(21) Appl. No.: 09/737,336

(22) Filed: Dec. 15, 2000

(51) Int. Cl. G06F 3/00; G06F 13/00; G06F 13/14; G06F 13/28

(52) U.S. Cl. 710/4; 710/35

(57) ABSTRACT

A method, apparatus, and computer implemented instructions for transferring data. A sender sends a plurality of data packets and a receiver receives a plurality of data packets. The data packet within the set of data packets includes a unit of data and an identifier of a location of the unit of data within the packet relative to units of data in other data packets within the plurality of data packets. Data from the units of data in the plurality of data packets are reassembled using indicators in the plurality of data packets.

### BACKGROUND OF THE INVENTION

1. Technical Field

The present invention relates generally to an improved network data processing system, and in particular to a method and apparatus for managing a network data processing system. Still more particularly, the present invention provides a method and apparatus for transferring data using a set of data packets.

2. Description of Related Art

In a system area network (SAN), the hardware provides a message passing mechanism which can be used for Input/Output devices (I/O) and interprocess communications between general computing nodes (IPC). Processes executing on devices access SAN message passing hardware by posting send/receive messages to send/receive work queues on a SAN channel adapter (CA). These processes also are referred to as “consumers”. The send/receive work queues (WQ) are assigned to a consumer as a queue pair (QP). The messages can be sent over five different transport types: Reliable Connected (RC), Reliable datagram (RD), Unreliable Connected (UC), Unreliable Datagram (UD), and Raw Datagram (RawD). Consumers retrieve the results of these messages from a completion queue (CQ) through SAN send and receive work completions (WC). The source channel adapter takes care of segmenting outbound messages and sending them to the destination. The destination channel adapter takes care of reassembling inbound messages and placing them in the memory space designated by the destination's consumer. Two channel adapter types are present, a host channel adapter (HCA) and a target channel adapter (TCA). The host channel adapter is used by general purpose computing nodes to access the SAN fabric. Consumers use SAN verbs to access host channel adapter functions. The software that interprets verbs and directly accesses the channel adapter is known as the channel interface (CI).

Network management operations often require the transfer of large amounts of information. Using an unreliable management datagram is inadequate because of the limited size of the payload or data area. For example, some datagram packets allow only 192 bytes of data. Therefore, it would be advantageous to have an improved method and apparatus for transferring data using limited size data packets.

### SUMMARY OF THE INVENTION

The present invention provides a method, apparatus, and computer implemented instructions for transferring data. A sender sends a plurality of data packets and a receiver receives a plurality of data packets. The data packet within the set of data packets includes a unit of data and an identifier of a location of the unit of data within the packet relative to units of data in other data packets within the plurality of data packets. Data from the units of data in the plurality of data packets are reassembled using indicators in the plurality of data packets.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a network computing system in accordance with a preferred embodiment of the present invention;

FIG. 2 is a functional block diagram of a host processor node in accordance with a preferred embodiment of the present invention;

FIG. 3 is a diagram of a host channel adapter in accordance with a preferred embodiment of the present invention;

FIG. 4 is a diagram illustrating processing of work requests in accordance with a preferred embodiment of the present invention;

FIG. 5 is an illustration of a data packet in accordance with a preferred embodiment of the present invention;

FIG. 6 is a diagram of a management datagram in accordance with a preferred embodiment of the present invention;

FIG. 7 is a flowchart of a process used for generating and sending data packets in accordance with a preferred embodiment of the present invention; and

FIG. 8 is a flowchart of a process used to receive and process data packets in accordance with a preferred embodiment of the present invention.

### DETAILED DESCRIPTION OF THE PREFERRED EMBODIMENT

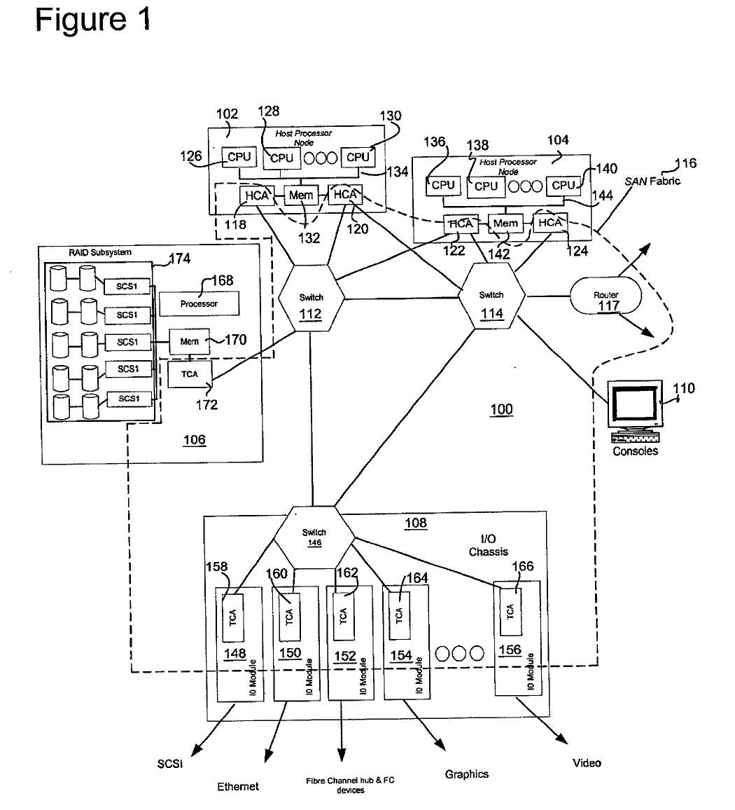

With reference now to the figures and in particular with reference to FIG. 1, a diagram of a network global change computing system is illustrated in accordance with a preferred embodiment of the present invention. The distributed computer system represented in FIG. 1 takes the form of a system area network (SAN) 100 and is provided merely for illustrative purposes, and the embodiments of the present invention described below can be implemented on computer systems of numerous other types and configurations. For example, computer systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by an internet or intranet.

SAN 100 is a high-bandwidth, low-latency network interconnecting nodes within the distributed computer system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, and I/O chassis node 108. The nodes illustrated in FIG. 1 are for illustrative purposes only, as SAN 100 can connect any number and any type of independent processor nodes, I/O adapter nodes, and I/O device nodes. Any one of the nodes can function as an endnode, which is herein defined to be a device that originates or finally consumes messages or frames in SAN 100.

In one embodiment of the present invention, an error handling mechanism in distributed computer systems is present in which the error handling mechanism allows for reliable connection or reliable datagram communication between end nodes in a distributed computing system, such as SAN 100.

A message, as used herein, is an application-defined unit of data exchange, which is a primitive unit of communication between cooperating processes. A packet is one unit of data encapsulated by a networking protocol headers and/or trailer. The headers generally provide control and routing information for directing the frame through SAN. The trailer generally contains control and cyclic redundancy check (CRC) data for ensuring packets are not delivered with corrupted contents.

SAN 100 contains the communications and management infrastructure supporting both I/O and interprocessor communications (IPC) within a distributed computer system. The SAN 100 shown in FIG. 1 includes a switched communications fabric 116, which allows many devices to concurrently transfer data with high-bandwidth and low latency in a secure, remotely managed environment. Endnodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing frames from one link in a first subnet to another link in a second subnet using a large header Destination Globally Unique Identifier (DGUID).

In one embodiment, a link is a full duplex channel between any two network fabric elements, such as endnodes, switches, or routers. Example of suitable links include, but are not limited to, copper cables, optical cables, and printed circuit copper traces on backplanes and printed circuit boards.

For reliable service types, endnodes, such as host processor endnodes and I/O adapter endnodes, generate request packets and return acknowledgment packets. Switches and routers pass packets along, from the source to the destination. Except for the variant CRC trailer field which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, and I/O chassis 108 include at least one channel adapter (CA) to interface to SAN 100. In one embodiment, each channel adapter is an endpoint that implements the channel adapter interface in sufficient detail to source or sink packets transmitted on SAN fabric 100. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144.

Host channel adapters 118 and 120 provide a connection to switch 112 while host channel adapters 122 and 124 provide a connection to switches 112 and 114.

In one embodiment, a host channel adapter is implemented in hardware. In this implementation, the host channel adapter hardware offloads much of central processing unit and I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communications (IPC) consumers of the distributed computer system with zero processor-copy data transfers without involving the operating system kernel process, and employs hardware to provide reliable, fault tolerant communications.

As indicated in FIG. 1, router 116 is coupled to wide area network (WAN) and/or local area network (LAN) connections to other hosts or other routers.

The I/O chassis 108 in FIG. 1 include an I/O switch 146 and multiple I/O modules 148-156. In these examples, the I/O modules take the form of adapter cards. Example adapter cards illustrated in FIG. 1 include a SCSI adapter card for I/O module 148; an adapter card to fiber channel hub and fiber channel-arbitrated loop (FC-AL) devices for I/O module 152; an ethernet adapter card for I/O module 150; a graphics adapter card for I/O module 154; and a video adapter card for I/O module 156. Any known type of adapter card can be implemented. I/O adapters also include a switch in the I/O adapter backplane to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or striped storage disk unit 174. Target channel adapter 172 can be a fully functional host channel adapter.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernel process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among themselves or communicate with any or all of the processor nodes in distributed computer system. With an I/O adapter attached to the SAN 100, the resulting I/O adapter node has substantially the same communication capability as any host processor node in SAN 100.

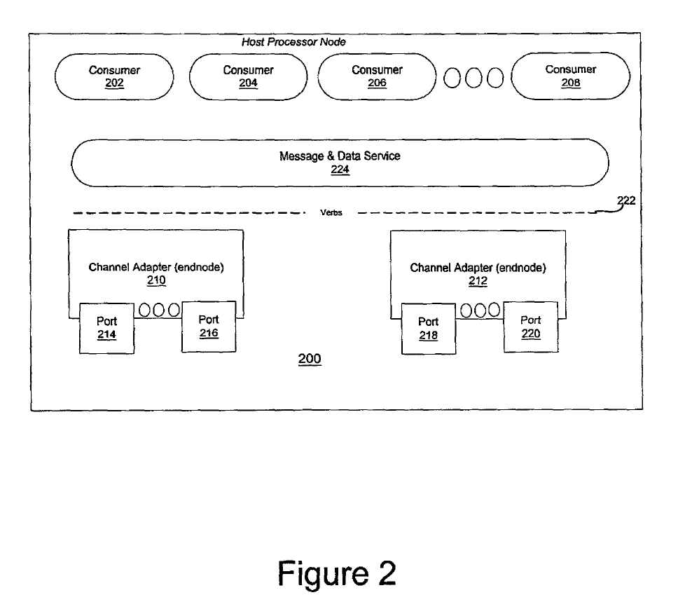

Turning next to FIG. 2, a functional block diagram of a host processor node is depicted in accordance with a preferred embodiment of the present invention. Host processor node 200 is an example of a host processor node, such as host processor node 102 in FIG. 1. In this example, host processor node 200 shown in FIG. 2 includes a set of consumers 202-208, which are processes executing on host processor node 200. Host processor node 200 also includes channel adapter 210 and channel adapter 212. Channel adapter 210 contains ports 214 and 216 while channel adapter 212 contains ports 218 and 220. Each port connects to a link. The ports can connect to one SAN subnet or multiple SAN subnets, such as SAN 100 in FIG. 1. In these examples, the channel adapters take the form of host channel adapters.

Consumers 202-208 transfer messages to the SAN via the verbs interface 222 and message and data service 224. A verbs interface is essentially an abstract description of the functionality of a host channel adapter. An operating system may expose some or all of the verb functionality through its programming interface. Basically, this interface defines the behavior of the host. Additionally, host processor node 200 includes a message and data service 224, which is a higher level interface than the verb layer and is used to process messages and data received through channel adapter 210 and channel adapter 212. Message and data service 224 provides an interface to consumers 202-208 to process messages and other data.

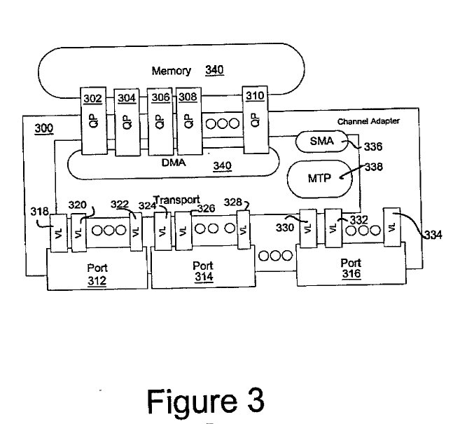

With reference now to FIG. 3, a diagram of a host channel adapter is depicted in accordance with a preferred embodiment of the present invention. Host channel adapter 300 shown in FIG. 3 includes a set of queue pairs (QPs) 302-310, which are used to transfer messages to the host channel adapter ports 312-316. Buffering of data to host channel adapter ports 312-316 is channeled through virtual lanes (VL) 318-334 where each VL has its own flow control. Subnet manager configures channel adapters with the local addresses for each physical port, i.e., the port's LID. Subnet manager agent (SMA) 336 is the entity that communicates with the subnet manager for the purpose of configuring the channel adapter. Memory translation and protection (MTP) 338 is a mechanism that translates virtual addresses to physical addresses and to validate access rights. Direct memory access (DMA) 340 provides for direct memory access operations using memory 340 with respect to queue pairs 302-310.

A single channel adapter, such as the host channel adapter 300 shown in FIG. 3, can support thousands of queue pairs. By contrast, a target channel adapter in an I/O adapter typically supports a much smaller number of queue pairs.

Each queue pair consists of a send work queue (SWQ) and a receive work queue. The send work queue is used to send channel and memory semantic messages. The receive work queue receives channel semantic messages. A consumer calls an operating-system specific programming interface, which is herein referred to as verbs, to place work requests (WRs) onto a work queue.

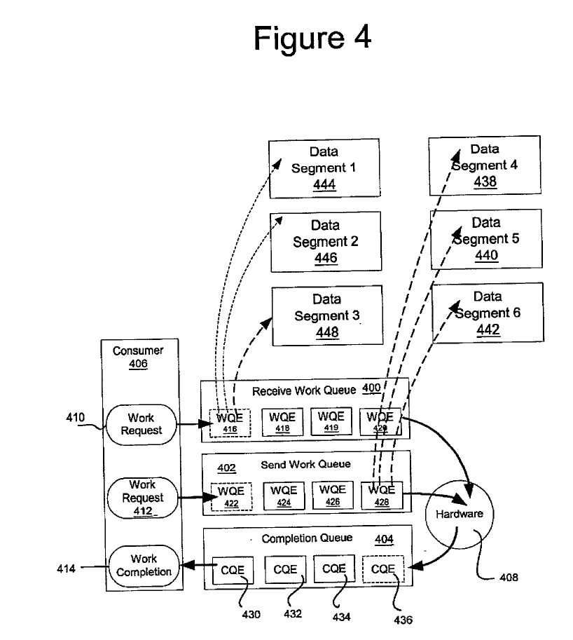

With reference now to FIG. 4, a diagram illustrating processing of work requests is depicted in accordance with a preferred embodiment of the present invention. In FIG. 4, a receive work queue 400, send work queue 402, and completion queue 404 are present for processing requests from and for consumer 406. These requests from consumer 406 are eventually sent to hardware 408. In this example, consumer 406 generates work requests 410 and 412 and receives work completion 414. As shown in FIG. 4, work requests placed onto a work queue are referred to as work queue elements (WQEs).

Send work queue 402 contains work queue elements (WQEs) 422-428, describing data to be transmitted on the SAN fabric. Receive work queue 400 contains work queue elements (WQEs) 416-420, describing where to place incoming channel semantic data from the SAN fabric. A work queue element is processed by hardware 408 in the host channel adapter.

The verbs also provide a mechanism for retrieving completed work from completion queue 404. As shown in FIG. 4, completion queue 404 contains completion queue elements (CQEs) 430-436. Completion queue elements contain information about previously completed work queue elements. Completion queue 404 is used to create a single point of completion notification for multiple queue pairs. A completion queue element is a data structure on a completion queue. This element describes a completed work queue element. The completion queue element contains sufficient information to determine the queue pair and specific work queue element that completed. A completion queue context is a block of information that contains pointers to, length, and other information needed to manage the individual completion queues.

Example work requests supported for the send work queue 402 shown in FIG. 4 are as follows. A send work request is a channel semantic operation to push a set of local data segments to the data segments referenced by a remote node's receive work queue element. For example, work queue element 428 contains references to data segment 4 438, data segment 5 440, and data segment 6 442. Each of the send work request's data segments contains a virtually contiguous memory region. The virtual addresses used to reference the local data segments are in the address context of the process that created the local queue pair.

A remote direct memory access (RDMA) read work request provides a memory semantic operation to read a virtually contiguous memory space on a remote node. A memory space can either be a portion of a memory region or portion of a memory window. A memory region references a previously registered set of virtually contiguous memory addresses defined by a virtual address and length. A memory window references a set of virtually contiguous memory addresses which have been bound to a previously registered region.

The RDMA Read work request reads a virtually contiguous memory space on a remote endnode and writes the data to a virtually contiguous local memory space. Similar to the send work request, virtual addresses used by the RDMA Read work queue element to reference the local data segments are in the address context of the process that created the local queue pair. For example, work queue element 416 in receive work queue 400 references data segment 1 444, data segment 2 446, and data segment 448. The remote virtual addresses are in the address context of the process owning the remote queue pair targeted by the RDMA Read work queue element.

A RDMA Write work queue element provides a memory semantic operation to write a virtually contiguous memory space on a remote node. The RDMA Write work queue element contains a scatter list of local virtually contiguous memory spaces and the virtual address of the remote memory space into which the local memory spaces are written.

A RDMA FetchOp work queue element provides a memory semantic operation to perform an atomic operation on a remote word. The RDMA FetchOp work queue element is a combined RDMA Read, Modify, and RDMA Write operation. The RDMA FetchOp work queue element can support several read-modify-write operations, such as Compare and Swap if equal.

A bind (unbind) remote access key (R_Key) work queue element provides a command to the host channel adapter hardware to modify (destroy) a memory window by associating (disassociating) the memory window to a memory region. The R_Key is part of each RDMA access and is used to validate that the remote process has permitted access to the buffer.

In one embodiment, receive work queue 400 shown in FIG. 4 only supports one type of work queue element, which is referred to as a receive work queue element. The receive work queue element provides a channel semantic operation describing a local memory space into which incoming send messages are written. The receive work queue element includes a scatter list describing several virtually contiguous memory spaces. An incoming send message is written to these memory spaces. The virtual addresses are in the address context of the process that created the local queue pair.

For interprocessor communications, a user-mode software process transfers data through queue pairs directly from where the buffer resides in memory. In one embodiment, the transfer through the queue pairs bypasses the operating system and consumes few host instruction cycles. Queue pairs permit zero processor-copy data transfer with no operating system kernel involvement. The zero processor-copy data transfer provides for efficient support of high-bandwidth and low-latency communication.

When a queue pair is created, the queue pair is set to provide a selected type of transport service. In one embodiment, a distributed computer system implementing the present invention supports four types of transport services.

Reliable and Unreliable connected services associate a local queue pair with one and only one remote queue pair. Connected services require a process to create a queue pair for each process, which is to communicate over the SAN fabric. Thus, if each of N host processor nodes contain P processes, and all P processes on each node wish to communicate with all the processes on all the other nodes, each host processor node requires P²×(N−1) queue pairs. Moreover, a process can connect a queue pair to another queue pair on the same host channel adapter.

Reliable datagram service associates a local end-end (EE) context with one and only one remote end-end context. The reliable datagram service permits a client process of one queue pair to communicate with any other queue pair on any other remote node. At a receive work queue, the reliable datagram service permits incoming messages from any send work queue on any other remote node. The reliable datagram service greatly improves scalability because the reliable datagram service is connectionless. Therefore, an endnode with a fixed number of queue pairs can communicate with far more processes and endnodes with a reliable datagram service than with a reliable connection transport service. For example, if each of N host processor nodes contain P processes, and all P processes on each node wish to communicate with all the processes on all the other nodes, the reliable connection service requires P²×(N−1) queue pairs on each node. By comparison, the connectionless reliable datagram service only requires P queue pairs+(N−1) EE contexts on each node for exactly the same communications.

The unreliable datagram service is connectionless. The unreliable datagram service is employed by management applications to discover and integrate new switches, routers, and endnodes into a given distributed computer system. The unreliable datagram service does not provide the reliability guarantees of the reliable connection service and the reliable datagram service. The unreliable datagram service accordingly operates with less state information maintained at each endnode.

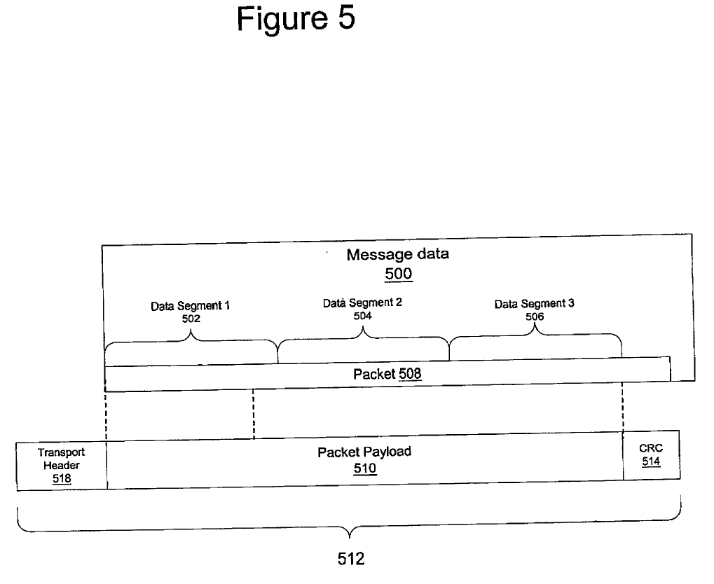

Turning next to FIG. 5, an illustration of a data packet is depicted in accordance with a preferred embodiment of the present invention. Message data 500 contains data segment 1 502, data segment 2 504, and data segment 3 506, which are similar to the data segments illustrated in FIG. 4. In this example, these data segments form a packet 508, which is placed into packet payload 510 within data packet 512. Additionally, data packet 512 contains CRC 514, which is used for error checking. Additionally, routing header 516 and transport 518 are present in data packet 512. Routing header 516 is used to identify source and destination ports for data packet 512. Transport header 518 in this example specifies the destination queue pair for data packet 512. Additionally, transport header 518 also provides information such as the operation code, packet sequence number, and partition for data packet 512. The operating code identifies whether the packet is the first, last, intermediate, or only packet of a message. The operation code also specifies whether the operation is a send RDMA write, read, or atomic. The packet sequence number is initialized when communications is established and increments each time a queue pair creates a new packet. Ports of an endnode may be configured to be members of one or more possibly overlapping sets called partitions.

If a reliable transport service is employed, when a request packet reaches its destination endnode, acknowledgment packets are used by the destination endnode to let the request packet sender know the request packet was validated and accepted at the destination. Acknowledgment packets acknowledge one or more valid and accepted request packets. The requester can have multiple outstanding request packets before it receives any acknowledgments. In one embodiment, the number of multiple outstanding messages is determined when a QP is created.

The present invention provides a method, apparatus, and computer implemented instructions for transferring data using data packets. In particular, the mechanism of the present invention involves transferring information using data packets referred to as MADs, which use the unreliable datagram service and which have limited payload. The mechanism of the present invention allows for the association of MADs together, as well as a means of identifying the relative position of data within each MAD with respect to all of the data forming the complete message. This ability is provided through additional fields place within the MADs in these examples.

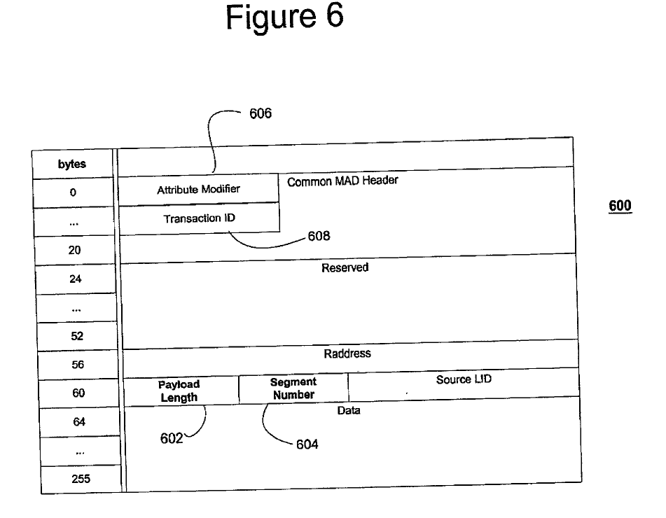

Turning next to FIG. 6, the diagram of a MAD is depicted in accordance with a preferred embodiment of the present invention. Data packet 600 is an example of the packet payload field, 510 of a data packet, such as, data packet 512 in FIG. 5. Data packet 600 represents a management datagram (MAD). In particular, data packet 600 could be an example of a MAD within a message used to transfer network configuration information. In the depicted examples, data packet 600 includes the following fields in addition to the standard fields which are present in all MADS: payload length field 602 and segment number field 604. Standard MAD fields used by the mechanism of the present invention include attribute modifier field 606 and transaction ID field 608. Segment number field 604 identifies the relative position of the packet within the message. Payload length field 602 is valid in the first packet of a message and specifies the length of the entire message. Attribute modifier field 606 identifyies the MAD as the first and/or last MAD of the message. Transaction ID field 608 identifies each MAD as part of a given message. The sender ensures that no two messages which it simultaneously sends contain the same transaction ID.

In processing a multi-data packet message, the sender of the message sends the entire message by sending each data packet that is part of the message within a pre-specified interpacket-send timeout of the previous data packet. All data packets, in these examples, except for the last data packet contain the maximum amount of data that may be placed into a data packet. All data packets forming the message contain the same transaction ID. In the depicted examples, the segment number field of each packet continuously increments by one with each packet of the message, and the attribute modifier field in the standard MAD header identifies the first, middle, and last packets of the message.

The requester receives the data packet for a message and starts a timer equal to the network transit time plus the interpacket-send timeout in these examples. Data from data packets received from the requestor are placed into a buffer to assemble the message.

If the timer expires, subsequent packets of the same message are discarded, and any resources associated with the operation may be released. When a packets are discarded in this manner, the recipient may request the sender to resend the message, but this request is not part of the present invention. The ULP will resend the message, if appropriate.

If an out-of-order packet is received, the packet is discarded and subsequent packets of the same message are discarded. Alternatively, the data may be placed in a buffer and arranged in the appropriate order. Such a case increases the complexity of the mechanism of the present invention and requires considerations, such as how long to wait for a missing packet.

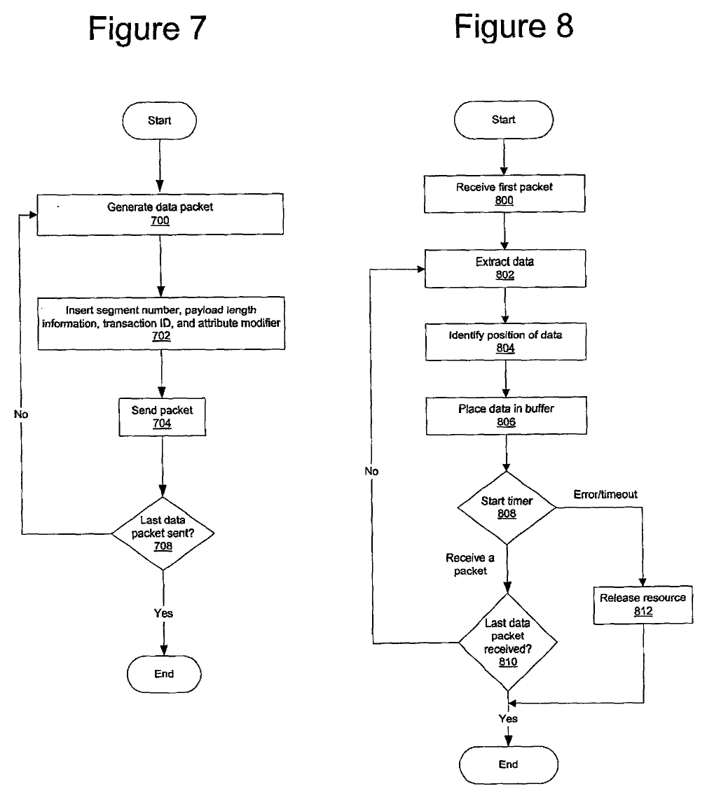

Turning next to FIG. 7, a flowchart of a process used for generating and sending data packets is depicted in accordance with a preferred embodiment of the present invention. This process may be implemented by a device, such as redundant array independent disk (RAID) subsystem node 106 in FIG. 1. The process generates a data packet set in which information is placed into each data packet forming the data packet set to allow a recipient of the data to identify data packets as being part of a data packet set. The data packet set is used to transfer data, such as a message.

The process begins by generating the first data packet to be sent (step 700). In this example, the data packet includes fields, such as those shown in MAD 600 in FIG. 6. Next, a segment number, payload length information, attribute modifier information, and transaction ID are selectively placed into the MAD (step 702). The attribute modifier information is placed into the data packet only if the data packet is a first or last data packet in the message.

The data packet is then sent to the requester (step 704). Next, a determination is made as to whether the data packet sent was the last data packet (step 710). If the data packet sent is the last data packet sent, then the process terminates. Otherwise, the process returns to step 700 to generate another data packet.

Turning next to FIG. 8, a flowchart of a process used to receive and process data packets is depicted in accordance with a preferred embodiment of the present invention. This process is implemented by a requestor requesting information, such as host processor node 102 in FIG. 1.

The process begins by receiving a first data packet (step 800). When the first data packet is received, it is identified by an attribute modifier within the data packet. Data packets are identified as being part of the same message based on a transaction ID in these examples. Further, multiple independent messages may be simultaneously received by concurrently executing the steps in FIG. 8, each for a different transaction ID.

The data is extracted from the data packet (step 802). The position of the data relative to other data received and being received is identified (step 804). The position of the data is identified by using information, such as the segment number placed into the data packet. This segment number allows reassembly of data from multiple data packets into a correct order to form the original message or response generated for the request. This data is placed into a buffer in a location relative to other data based on the segment number (step 806).

Next, a timer is started (step 808). Upon receiving a data packet, a determination is made as to whether the data packet is a last data packet (step 810). In these examples, whether a data packet is a last data packet may be determined by examining the attribute modifier field in the data packet. If the data packet is the last data packet, the process terminates. Otherwise the process returns to step 802 as described above.

Referring back to step 808, if an error or a timeout occurs, the resource used to process data packets is released (step 812) with the process terminating thereafter.

Thus, the present invention provides a method, apparatus, and computer implemented instructions for transferring data. In particular, a protocol is used to provide for recognition of the error-free receipt of a multipacket message. Further, the protocol allows resources to be released in a timely manner when errors occur. The data packet fields an associated processes may be implemented in both software and firmware.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for transferring data, the method comprising:
receiving a plurality of data packets, wherein a data packet within the set of data packets includes a unit of data, an identifier identifying the packet as a member of a particular plurality of packets, and an identifier of a location of the unit of data within the packet relative to units of data in other data packets within the plurality of data packets; and
reassembling data from the units of data in the plurality of data packets using indicators in the plurality of data packets.

2. The method of claim 1 further comprising:
allocating resources to process the plurality of data packets; and
releasing the resources in response to an absence of a receipt of all data packets needed to complete receipt of the data.

3. The method of claim 1, wherein the identifier identifies a location of a unit of data as a first unit of data.

4. The method of claim 1, wherein the identifier identifies a location of a unit of data as a last unit of data.

5. The method of claim 1, wherein the identifier identifies a location of a unit of data as a middle unit of data.

6. The method of claim 1, wherein the identifier identifies a location of a unit of data as an only unit of data.

7. The method of claim 1, wherein the plurality of data packets is a plurality of management datagrams.

8. The method of claim 1, wherein the identifier is a flag placed in a header of a data packet.

9. A method in a data processing system for transferring data, the method comprising:
placing units of the data into a plurality of data packets;
placing an identifier for each unit in a data packet within the plurality of data packets, wherein the identifier indicates a location for a unit of data relative to other units of data; and
sending the plurality of data packets to the requester.

10. The method of claim 9, wherein the identifier identifies a location of a unit of data as a first unit of data.

11. The method of claim 9, wherein the identifier identifies a location of a unit of data as a last unit of data.

12. The method of claim 9, wherein the identifier identifies a location of a unit of data as a middle unit of data.

13. The method of claim 9, wherein the identifier identifies a location of a unit of data as an only unit of data.

14. The method of claim 9, wherein the plurality of data packets is a plurality of management datagrams.

15. The method of claim 9, wherein the identifier is a flag placed in a header of a data packet.

16. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to receive a plurality of data packets, wherein a data packet within the set of data packets includes a unit of data and an identifier of a location of the unit of data within the packet relative to units of data in other data packets within the plurality of data packets; and reassemble data from the units of data in the plurality of data packets using indicators in the plurality of data packets.

17. The data processing system of claim 16, wherein the bus system includes a primary bus and a secondary bus.

18. The data processing system of claim 16, wherein the processor unit includes a single processor.

19. The data processing system of claim 16, wherein the processor unit includes a plurality of processors.

20. The data processing system claim 16, wherein the communications unit is an Ethernet adapter.

21. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to place units of the data into a plurality of data packets; place an identifier for each unit in a data packet within the plurality of data packets, wherein the identifier indicates a location for a unit of data relative to other units of data; and send the plurality of data packets to the requester

22. A data processing system for transferring data, the data processing system comprising:
receiving means for receiving a plurality of data packets, wherein a data packet within the set of data packets includes a unit of data and an identifier of a location of the unit of data within the packet relative to units of data in other data packets within the plurality of data packets; and
reassembling means for reassembling data from the units of data in the plurality of data packets using indicators in the plurality of data packets.

23. The data processing system of claim 22 further comprising:
allocating means for allocating resources to process the plurality of data packets; and
releasing means for releasing the resources in response to an absence of a receipt of all data packets needed to complete receipt of the data.

24. The data processing system of claim 22, wherein the identifier identifies a location of a unit of data as a first unit of data.

25. The data processing system of claim 22, wherein the identifier identifies a location of a unit of data as a last unit of data.

26. The data processing system of claim 22, wherein the identifier identifies a location of a unit of data as a middle unit of data.

27. The data processing system of claim 22, wherein the identifier identifies a location of a unit of data as an only unit of data.

28. The data processing system of claim 22, wherein the plurality of data packets is a plurality of management datagrams.

29. The data processing system of claim 22, wherein the identifier is a flag placed in a header of a data packet.

30. A data processing system for transferring data, the data processing system comprising:
first placing means for placing units of the data into a plurality of data packets;
second placing means for placing an identifier for each unit in a data packet within the plurality of data packets, wherein the identifier indicates a location for a unit of data relative to other units of data; and
sending means for sending the plurality of data packets to the requester.

31. The data processing system of claim 30, wherein the identifier identifies a location of a unit of data as a first unit of data.

32. The data processing system of claim 30, wherein the identifier identifies a location of a unit of data as a last unit of data.

33. The data processing system of claim 30, wherein the identifier identifies a location of a unit of data as a middle unit of data.

34. The data processing system of claim 30, wherein the identifier identifies a location of a unit of data as an only unit of data.

35. The data processing system of claim 30, wherein the plurality of data packets is a plurality of management datagrams.

36. A computer program product in a computer readable medium for use in transferring data in a data processing system, the computer program product comprising:
first instructions for receiving a plurality of data packets, wherein a data packet within the set of data packets includes a unit of data and an identifier of a location of the unit of data within the packet relative to units of data in other data packets within the plurality of data packets; and
second instructions for reassembling data from the units of data in the plurality of data packets using indicators in the plurality of data packets.

37. The computer program product claim 36 further comprising:
third instructions for allocating resources to process the plurality of data packets; and
fourth instructions for releasing the resources in response to an absence of a receipt of all data packets needed to complete receipt of the data.

38. A computer program product in a computer readable medium for transferring data in data processing system, the computer program product comprising:
second instructions for placing units of the data into a plurality of data packets;
third instructions for placing an identifier for each unit in a data packet within the plurality of data packets, wherein the identifier indicates a location for a unit of data relative to other units of data; and
fourth instructions for sending the plurality of data packets to the requestor.
